(19) United States
(12) Patent Application Publication
(10) Pub. No.: US 2001/0028242 A1
(43) Pub. Date: Oct. 11, 2001

(54) Load supply voltage regulator assembly

(76) Inventor: Erich Bayer, Thonhausen (DE)

Correspondence Address: W. Daniel Swayze, Jr., M/S 3999/ Patent Activity, P.O. Box 655474, Dallas, TX, 75265, US

(21) Appl. No.: 09/811,297

(22) Filed: Mar. 16, 2001

(30) Foreign Application Priority Data
Mar. 31, 2000 (DE) 100 16 168.5

(51) Int. Cl. G05F 3/16

(52) U.S. Cl. 323/315

(57) ABSTRACT

A load supply voltage regulator assembly including a regulation loop containing a differential amplifier (12) whose input (28) receives a signal as a function of the load supply voltage and whose output (50) furnishes a regulation signal as a function of the deviation of the supply voltage from a nominal value as a regulation variable prompting a controlled system (56) in said regulation loop to eliminate the deviation of the supply voltage from the nominal value. The gain of the differential amplifier (12) can be switched from a low to a high value when the supply voltage changes to values violating a predefined nominal voltage range due to a change in the current requirement of the load (58).

The invention relates to a load supply voltage regulator assembly including a regulation loop containing a differential amplifier whose input receives a signal as a function of the load supply voltage and whose output furnishes a regulation signal as a function of the deviation of the supply voltage from a nominal value as a regulation variable prompting a controlled system in said regulation loop to eliminate the supply voltage deviation from the nominal value.

As a rule electronic devices need to be powered by a fixedly defined supply voltage. To maintain this supply voltage constant separate regulator modules are made use of which ensure that this supply voltage is maintained constant within defined limits independent of fluctuations in the current requirement of the load fed by this voltage. Examples of such regulator modules are series 78xx offered by many manufacturers, xx indicating the output voltage of the regulator module, where, for example, xx=05 means that the regulator module outputs a constant voltage of 5 V. When the load receiving the supply voltage from the regulator module is a dynamic load, the impedance of which varies, although the regulator module is able to regulate the supply voltage to the setpoint value of the supply voltage after a change in impedance, this regulation action takes up a certain time during which a noticeable deviation in the supply voltage from the setpoint value occurs. When the load, for example, includes in addition to electronic circuits having only a low current requirement, a motor which on power up requires a substantially higher current, then the supply voltage initially drops to a lower value on power up of the motor before then being regulated by the regulator module back to the setpoint value. Despite the time during which the supply voltage drops to the lower value being shortened by providing at the output of the regulator module a buffer capacitor which is capable of supplying the higher current to the motor required during this transition period, this capacitor would have to have such a high capacitance that this possibility of shorting the time needed for the regulation action cannot be put to use in many applications both from cost considerations and as regards the limited space available. The regulator module cannot be configured directly so that it more quickly reacts to changes in the load impedance since there is otherwise the risk of the regulation system oscillating.

The invention is thus based on the object of configuring a load supply voltage regulator assembly of the aforementioned kind so that very fast correction of the supply voltage is achieved when there is a change in impedance, without having to include a large buffer capacitor.

This object is achieved in accordance with the invention in that the gain of the differential amplifier can be switched from a low value to a high value when the supply voltage changes to values violating a predefined nominal voltage range due to a change in the current requirement of the load.

The assembly in accordance with the invention is able to operate in two modes. In one operating mode the differential amplifier has a low gain whilst this differential amplifier in the other mode has a high gain. The low gain is effective when the load impedance changes either hardly or not at all so that the fluctuations in the supply voltage occurring due to the change in impedance, to be compensated by the regulation action, remain within a predefined nominal voltage range. As soon as the change in the load impedance is so large, however, that the supply voltage to be regulated exceeds the nominal voltage range, then the gain of the differential amplifier is switched to a high value so that a high current is furnished temporarily by the controlled system which can flow to the load and ensure that the change in the supply voltage is very quickly returned to within the nominal voltage range in which the low gain is again effective. It is in this way that fast correction of the supply voltage is achieved without a large buffer capacitor, even when a heavy change in impedance of the load occurs. Since the high gain is effective only for a relatively short time there is also no risk of the regulator assembly starting to oscillate. Due to the fast correction a return is made to the low gain value in a very short time in which there is no tendency for oscillations.

Advantageous futher embodiments of the invention are characterized in the sub-claims.

The invention will now be detained by way of an example with reference to the drawing in which:

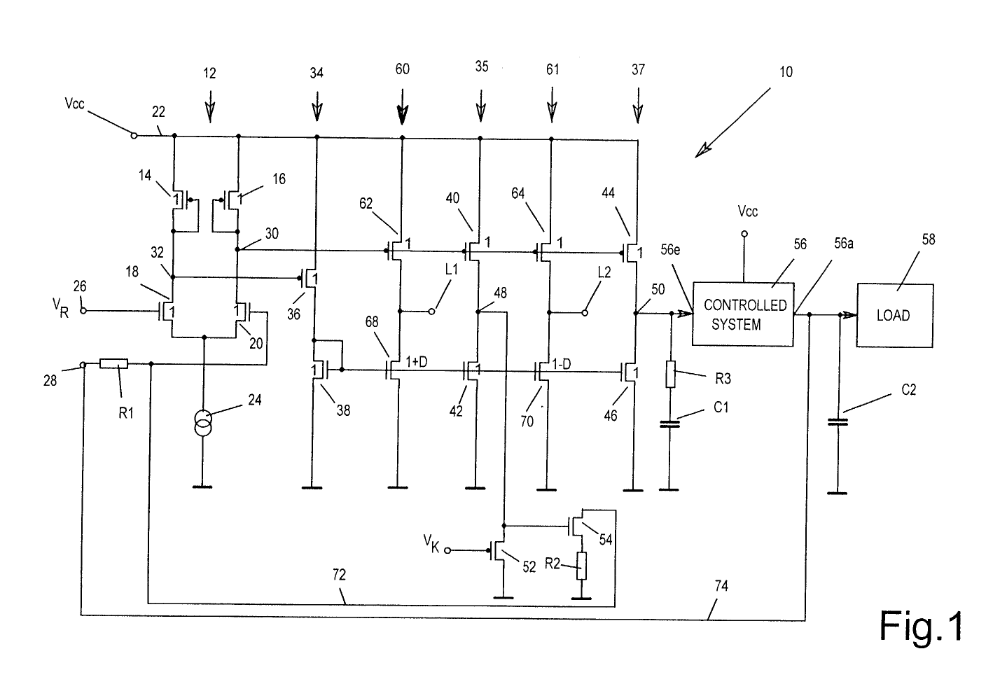

FIG. 1 is a circuit diagram of the regulator assembly in accordance with the invention and

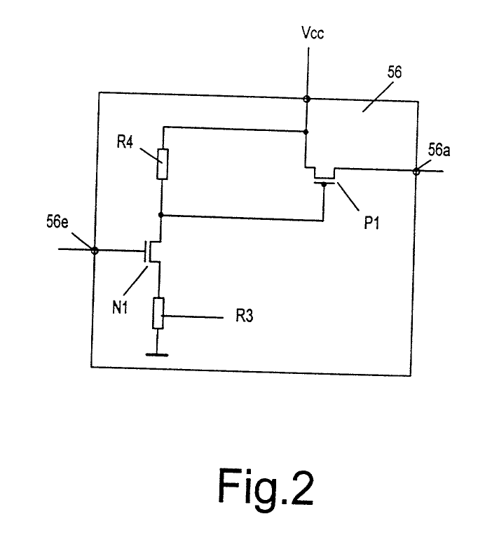

FIG. 2 is an example for the configuration of the controlled system shown as a block in FIG. 1.

Referring now to FIG. 1 there is illustrated the assembly 10 containing a differential amplifier 12 with two circuit branches containing a PMOS transistor 14, 16 connected as a diode and a NMOS transistor 18 and 20 respectively connected thereto in series. The drains of the PMOS transistor 14 and 16 are connected to the supply voltage conductor 22 and the connected sources of the NMOS transistors 18 and 20 are connected to one terminal of a current source 24, the other terminal of which is connected to ground. The “+”-input 26 of the differential amplifier 12 is connected to the gate of the NMOS transistor 18 and the “−”input 28 is connected via a resistor R1 to the gate of the NMOS transistor 20.

The circuit point 30 forms an output of the differential amplifier 12; this output being connected to several output stages in the way as detained later. The circuit point 32 likewise forms an output of the differential amplifier 12; it being initially connected to a circuit part 34 consisting of the series arrangement of a PMOS transistor 36 with a NMOS transistor 38 connected as a diode and which merely serves to place the reference point of the voltages taken from the output stages so that a symmetrical output voltage is made available at the output stages within the predefined dynamic range.

For the regulating function two output stages, namely output stages 35 and 37 are provided. The output stage 35 consists of the series arrangement of a PMOS transistor 40 and a NMOS transistor 42 whilst the output stage 37 is made up of the series circuit of a PMOS transistor 44 and a NMOS transistor 46. The output voltage is tapped in each case from the connecting point 48 or 50 of the two transistors in each output stage. The connecting point 48 is connected to the drain of a PMOS transistor 52, the source of which is grounded. Connected to the gate of this PMOS transistor 52 is a fixed clamping voltage VK. Further connected to the connecting point 48 is the gate of a NMOS transistor 54, the drain of which is connected to the gate of the NMOS transistor 20 in the differential amplifier 12 whilst its source is grounded via a resistor R2.

Connected between the circuit point 50 and ground is the series arrangement of a resistor R3 and a capacitor C1. Furthermore, the circuit point 50 is connected to the input 56e of a controlled system 56, the configuration of which will be detained with reference to FIG. 2. The output 56a of the controlled system 56 is connected to the “−”-input 28 of the differential amplifier 12 and is connected to a load 58 the supply voltage of which is to be regulated. Further connected between the input of the load 58 and ground is a buffer capacitor C2.

Referring now to FIG. 2 there is illustrated one example of the configuration of the controlled system 56. This controlled system comprises an input 56e and an output 56a. The input 56e is connected to the gate of a NMOS transistor N1, the source of which is grounded via a resistor R3. The drain of the NMOS transistor N1 is connected to the gate of a PMOS transistor P1 and to one terminal of a resistor R4, the other terminal of which is connected to the drain of this PMOS transistor P1. The source of the PMOS transistor P1 is connected to the output 56a. This controlled system provides a current at the output 56a which is proportional to the voltage at the input 56e.

In the assembly as shown in FIG. 1 two further output stages 60 and 61 are provided which like the other output stages consist of the series arrangement of a PMOS transistor 62, 64 and a NMOS transistor 69 and 70 respectively. Provided at the connecting point of the two transistors in each output stage is an output L1 and L2 respectively, the purpose of which will be explained later.

One salient requirement for the assembly as described to function satisfactorily is that the transistors or groups of transistors employed are very accurately the same and each has precisely the same ratio of channel length to channel width. Only the two transistors 68 and 70 differ from this requirement as will be explained later. In FIG. 1 it is assumed that all transistors have the same ratio of channel length to channel width as is illustrated by all transistors the same each being identified by the number 1 whilst the transistors 68 and 70 are identified by the value 1+D and 1−D respectively to illustrate this difference. In principle, however, it is sufficient when all PMOS transistors and with the exception of the transistors 68 and 70 all NMOS transistors are the same in the output stages and when the PMOS and NMOS transistors in the differential amplifier 12 are the same each in pairs.

In the following description it is assumed for the functioning of the assembly as shown in FIG. 1 that the load consists of the electronic circuitry of a notebook computer whose current requirement changes as a function of the operating mode. One particularly critical situation is when the electronic circuitry of the notebook computer is automatically returned to sleep after a lengthy operating period and is then required to instantly wake up fully operative with a relatively high current consumption when a key is pressed. This change to a high current consumption requires the regulator assembly to bring the supply voltage back into the nominal voltage range as quickly as possible after a transient unavoidable collapse to prevent a loss of data due to staying too long at a low voltage value.

Assuming first the case in which the load 58 requires a nominal current changing only slightly, the regulator assembly needs to compensate merely slight changes in the supply voltage occurring due to minor fluctuations in the load.

Available at the gate of the PMOS transistor 52 is always a highly stable clamping voltage V_{K} and at the “+”-input 26 of the differential amplifier 12 likewise a stable reference voltage V_{R} which in the example as described may equal the clamping voltage V_{K}.

Assuming now normal operation the differential amplifier 12 operates in the low gain mode since it receives via the conductor 72 a negative feedback current. This negative feedback current changes as a function of the voltage at the connecting point 48 of the PMOS transistor 36 as long as this voltage moves within the dynamic range defined as follows. The lower limit of the dynamic range is defined by the threshold voltage value V_{T54} of the NMOS transistor 54 since the negative feedback current cannot flow until this transistor is ON which is only the case when the voltage at its gate exceeds its threshold voltage value. The negative feedback current can only change, however, as long as the PMOS transistor 52 is OFF. This PMOS transistor 52 is not ON until the voltage at the connecting point 48 exceeds the sum of the fixed clamping voltage V_{K} and its threshold voltage V_{T52}. As soon as the PMOS transistor 52 is ON the gate voltage at the NMOS transistor 54 can no longer change so that accordingly no further change in the negative feedback current occurs. Since, as explained above, the two transistors 52 and 54 are the same in size they also have more or less the same threshold voltage values so that the dynamic range roughly corresponds to the value of the fixed clamping voltage V_{K}. The threshold voltage values of the two transistors 52 and 54 are slightly different due to the fact that the one transistor is a PMOS transistor and the other is a NMOS transistor, this being, however, irrelevant for the described functioning of the circuit as a whole.

Thus, as long as the voltage at the point 48 remains within the dynamic range as explained above, the differential amplifier 12 has negative feedback due to the negative feedback current changing with the changes in the voltage at the connecting point 48 so that its gain is correspondingly low. The same voltage appearing at the circuit point 48 also appears at the circuit point 50 which is connected to the input of the controlled system 56. Also provided at the input of the controlled system is the series circuit of the resistor R3 and capacitor C1 as explained above which has the task of influencing the phasing of the voltage at the input of the controlled system 56 in each case so that no oscillations can occur in normal operation of the circuit.

As explained above, the controlled system 56 generates at its output a current proportional to the voltage at the circuit point 50 which in each case compensates the changing current requirement of the load 58 so that its supply voltage remains constant.

Assuming now the case in which the impedance of the load 58 drops from a high value to a low value, a substantially higher load current flows to the load. Due to its finite response the regulator assembly is unable to instantly react to this increased current requirement, resulting in the supply voltage suffering a sharp drop at the load 58. Although the buffer capacitor C2 is able to provide the load 58 with a minor proportion of the current required, its capacitance is not sufficient to return the supply voltage to the load 58 to the necessary nominal value quick enough. It is here that the special configuration of the regulator assembly in accordance with the invention ensures that the supply voltage is quickly returned to within the nominal range.

Via the connecting conductor 74 the sharp drop in the supply voltage is applied to the “⁻”-input 28 of the differential amplifier 12 so that due to the resulting difference between the voltages at the “⁺”-input 26 and “⁻”-input 28 at the connecting point 48 of the PMOS transistor 36 a voltage is generated which is larger that the sum of the fixed clamping voltage V_{K} and the threshold voltage V_{T52} of the PMOS transistor 52. As soon as this output voltage at the connecting point 48 exceeds this sum of the clamping voltage and the threshold voltage of the PMOS transistor 52 there is no further change in the voltage at the gate of the NMOS transistor 54 even with a further increase in the voltage at the connecting point 48 so that the negative feedback current in the conductor 72 remains constant. The differential amplifier responds to this by reacting to any further change in the voltage applied to its “−”−input 28 as an amplifier having no negative feedback, whose gain factor is substantially increased as compared to the gain factor in the negative feedback condition. Due to this other operating mode of the differential amplifier 12 a very steep increase in the voltage results at the circuit point 50 which is converted by the controlled system 56 into a steep increase in the current supplied to the load 58. This increase in current results in a fast increase in the voltage at the load resulting in the voltage at the connecting point 48 and circuit point 50 returning to low values until, in the end the PMOS transistor 52 is returned OFF and the negative feedback current at the PMOS transistor 52 again changes as a function of the change in voltage at the load. The differential amplifier 12 then reacts again as a negative feedback amplifier, i.e. as an amplifier having a low gain factor.

It is to be noted that for satisfactory functioning of the regulator assembly as described it is important that the operating mode in which the differential amplifier 12 reacts as a amplifier having no negative feedback lasts for only a very short time since in this operating mode the regulator assembly has a very strong tendency to oscillate. Since as described above, due to the high gain factor in this operating mode the high current requirement of the load 58 is very quickly satisfied and the supply voltage at the load thus very quickly increases to values within the nominal range, the stable operating mode with the negative feedback differential amplifier is automatically reachieved after a brief period so that the complete regulator assembly exhibits a stable response.

The regulator assembly is able to quickly react not only to a sudden jump in the current flowing to the load 58, its reaction is just as fast to a likewise sudden drop in the load current. In this case the voltage at the load 58 is able to increase to values exceeding the nominal range. This results in the voltage at the load 58 of the output stage 37 dropping to a value below the threshold voltage of the NMOS transistor 54 signalling this transistor OFF. The negative feedback current on the PMOS transistor 52 is thus interrupted so that the differential amplifier 12 changes in this case too into the operating mode in which it has the very high gain. The low voltage at the circuit point 50 prompts the regulation 56 to drop the current from the load 58 so that the supply voltage is quickly returned to lower values within the nominal range. Here too, the condition materializes in which the differential amplifier 12 works without negative feedback only for a short time period so that the assembly exhibits no tendency to oscillate.

The regulator assembly as described thus results in a fast correction of the load supply voltage to a value within the nominal range for both a sudden increase and a sudden drop in the load current, achieving in both cases switching from a low to a high value of the gain factor of the differential amplifier 12 by the negative feedback being rendered ineffective in both cases. In this arrangement it is assured that this operating mode with no negative feedback only exists for a short time period before it is automatically returned to the operating mode with negative feedback.

With the aid of the signals output at the output L1 and L2 the additional output stages 60 and 61 enable every violation of the nominal range of the supply voltage of the load 58 to be indicated. By differingly dimensioning the series circuit of the output stages, transistor 68 and 64, 70 respectively in these output stages the signal at the output L1 can be made use of to indicate MAX violation of the nominal range and the signal at the L2 to indicate MIN violation of the nominal range. Defined indication of the violation in this way is possible because only one of the two transistors in the series circuit is ON in each case in both output stages on violation of the nominal range so that accordingly a signal is made available at the output L1 and L2 which is accordingly usable to achieve the described indication. Since violation of the nominal range is fleeting a flip-flop, for example, may be connected to the outputs L1 and L2 in each case which is signalled to characterize the indication in each case so that a suitable indicator lamp is signalled ON accordingly.

1. A load supply voltage regulator assembly including a regulation loop containing a differential amplifier whose input receives a signal as a function of the load supply voltage and whose output furnishes a regulation signal as a function of the deviation of said supply voltage from a nominal value as a regulation variable prompting a controlled system in said regulation loop to eliminate said supply voltage deviation from said nominal value, characterized in that the gain of said differential amplifier (12) can be switched from a low value to a high value when said supply voltage changes to values violating a predefined nominal voltage range due to a change in the current requirement of said load (58).

2. The assembly as set forth in claim 1, characterized in that said differential amplifier (12) comprises a first output stage (35) outputting an output voltage corresponding to said regulation signal, said output voltage being applied to the input of a feedback circuit (52, 54, R2, 72) which supplies said differential amplifier input with a negative feedback current as a manipulated variable which changes as a function of said output voltage until said regulation signal is in a range within said nominal voltage range of said supply voltage and does not change when said regulation signal attains the upper or lower limit of this range.

3. The assembly as set forth in claim 2, characterized in that said feedback circuit contains a first circuit part (52) for defining said upper limit of said changing range of said negative feedback current and a second circuit part for defining said lower limit of said changing range of said negative feedback current.

4. The assembly as set forth in claim 3, characterized in that said first circuit part is a PMOS transistor (52) the source of which receives a signal corresponding to the regulation signal and the gate of which receives a fixed clamping voltage (VK) and that the second circuit part contains a NMOS transistor the source-drain circuit of which is connected to ground via a resistor (R2) and the drain of which furnishes said negative feedback current.

5. The assembly as set forth in any of the claims 1 to 4, characterized in that said differential amplifier (12) comprises a second output stage (37) connected in parallel to said first output stage (35) and which likewise furnishes said output voltage corresponding to the regulation signal and that said output stage is connected to a compensating member comprising a series circuit connected to ground comprising a resistor (R3) and a capacitor (Cl) and is connected to said controlled system (56).

6. The assembly as set forth in any of the claims 1 to 5, characterized in that said differential amplifier (12) comprises two further output stages (60, 61), each of which contains a series circuit of a PMOS transistor (62, 64) and a NMOS transistor (68, 70), said PMOS transistors being driven from a first output (30) of said differential amplifier (12) and said NMOS transistor being driven from a second output (32) of said differential amplifier (12) and that at the connecting point of said two transistors in each output stage an output terminal is provided at which a signal characterizing the mode of said regulation loop can be tapped.
